(19) United States
(12) Patent Application Publication
(10) Pub. No.: US 2005/0202313 A1
(43) Pub. Date: Sep. 15, 2005

(54) Device for measuring and regulating the ph-value of a medium

(76) Inventors: Reiner Franzheld, Waldheim (DE); Torsten Pechstein, Radebeul (DE); Katrin Scholz, Bobritzsch (DE)

Correspondence Address: BACON & THOMAS, PLLC, 625 SLATERS LANE, FOURTH FLOOR, ALEXANDRIA, VA, 22314, US

(21) Appl. No.: 10/506,243

(22) PCT Filed: Feb. 26, 2003
(86) PCT No.: PCT/EP03/01958

§ 371 Date: May 17, 2005

(30) Foreign Application Priority Data
Mar. 8, 2002 (DE) 102 10 060.8

(51) Int. Cl. H01M 6/00; H01M 10/00

(52) U.S. Cl. 429/122

(57) ABSTRACT

A reference half-cell for use in a potentiometric measuring cell for determining ionic activities in a solution being measured. Additionally, a bridge electrolyte and a method for the synthesis of this bridge electrolyte are discussed. The bridge electrolyte comprises a cationic gel based on diallyldimethylammonium chloride (DADMAC), into which a reference electrolyte is incorporated.

The invention relates to a reference half-cell for use in a potentiometric cell for measuring ion activities in a solution. Additionally, the invention relates to a bridge electrolyte and a method for synthesis of this bridge electrolyte.

Measurement of pH in a solution using a potentiometric measuring chain is described in detail, for example, in ‘Abwasser-Meβ- und Regeltechnik (Wastewater Measurement and Regulating Technology)’, Published by Endress+Hauser Holding AG, 1st Printing, 2nd Edition, Pg. 83 et seq., and in the book: ‘pH-Messung: Grundlagen, Methoden, Anwendungen, Geräte (pH-Measurement: Fundamentals, Methods, Applications, Equipment)’, Weinheim: VCH, 1990, Chapter 1.6, Pg. 20 et seq.

A most important instrument for the electrochemical measurement and regulating of pH is the so-called glass electrode, which finds broad application in many areas of chemistry, environmental analysis, medicine, industry and water management. Glass electrodes for a wide variety of applications are offered and sold by the assignee. The glass electrodes used for potentiometric measurements usually include reference half-cells, which provide extremely constant potentials. As a rule, silver/silver-chloride or calomel electrodes are used.

The contact of the reference element with the solution being measured is produced via a bridge electrolyte, which can be liquid or solid and fulfills certain prerequisites: On the one hand, it should not influence the potential of the reference element to any significant degree; on the other hand, it should form with the medium being measured as small a diffusion potential as possible.

Particularly the use of reference half-cells having solidified electrolyte offers many advantages:
the electrodes have low maintenance;
if the process is under pressure, then no pressure loading of the electrolytes must occur;
the replenishment of electrolyte is unnecessary;
components of the solution being measured that diffuse into the reference half-cell cannot be transported by convection to the reference element. Therefore, the reference element is well protected against a sudden “poisoning”.

The above-mentioned advantages make a reference half-cell with solidified electrolyte naturally very attractive for the pH-electrodes manufacturer. However, the potential of such reference half-cells exhibits a relatively strong dependence on the conditions of use prevailing at the site of measurement.

The measurement errors, respectively the problems, which arise in the case of conventional pH-electrodes having solidified electrolytes, are as follows:
Due to the lacking electrolyte outflow, a diffusion takes place in both directions of the reference half-cell. “Electrode poisons” can, consequently, gradually get into the reference half-cell. Also, the reference electrolyte is slowly diluted by the solution being measured, which ultimately leads to a change of the potential of the reference half-cell.
In the use of the conventional gels, significantly delayed adjustment times are experienced. These delayed adjustment times can lead likewise to serious measurement errors. Under unfavorable circumstances, these measurement errors can lead to a pH-value change of 0.5.

The polymer chemical basis for gel-filled pH-glass-electrodes is currently primarily polyacrylamide. Preferably, the gel is produced during manufacture of the electrodes by polymerization of the appropriate monomers directly in the glass body. A corresponding reference half-cell, respectively a corresponding reference electrode, and a corresponding measuring chain are described in DE 32 28 647 A1.

From the point of view of those concerned with production, doing the polymerization in the glass body is not unconditionally of advantage, since only a limited amount of time is available for the filling of the electrode bodies with the pre-activated monomer solutions. Moreover, in view of the proven strongly carcinogenic properties of acrylamide, the authorities have written strict regulations on protective working precautions for contact with this monomer. Correspondingly strict regulations hold also for the waste disposal of polymerized residues of the gel material; the residues of the gel materials must be handled as hazardous waste.

Alternative manufacturing methods contemplate the swelling of dried polymerizate as needed with water or the mechanical comminution of an externally readied gel and the provision of suitable additives (e.g. glycol) to obtain a flowable condition. The advantage of this method is that a workable gel can be kept available over a longer period of time. It has been found that the gels prepared outside of the pH-electrodes can be very strongly influenced by changing conditions in the measuring process. Already in the case of relatively moderate pH-values, respectively temperatures, the pH-electrode can fail, because the gel becomes partially or completely liquified; as a result, it can easily escape through the diaphragm, so that the previous filling of the electrode body of the reference half-cell is no longer present.

It remains to be mentioned that also the in-situ prepared, polyacrylamide-based gel systems have only a limited resistance to aging. The reason for this is the—especially under strongly alkaline conditions—relatively low hydrolysis-stability of these hydrophilic gels. These gel changes can ultimately lead to an instability in the potential of the reference half-cell, respectively to a complete failure, of the pH-electrode.

The mentioned gels exhibit, moreover, a different thermal expansion behavior with temperature change, as compared with the usually selected stem glasses of the pH-electrodes. This can lead, under process conditions, to changes and stresses in the pH-electrode, and thence to cracks in the glass and, thus, to failure of the electrode.

The recently proposed gel fillings of hydrophilic gels based on polyglycosides can scarcely present a sensible alternative, alone on the basis of price. Moreover, these gels also change their properties over time, so that even with these materials the principal difficulty of problematic resistance to aging cannot be solved.

On the basis of the above-presented considerations, it is clear that the reference half-cell materially influences the range of applications of a pH measuring chain. A reference half-cell which is as universally applicable as possible must deliver an essentially constant half-cell potential independently of the conditions of its environment. In particular, this half-cell potential cannot be permitted to change, in certain cases even irreversibly, as a function of temperature and pH-value. Additionally, the reference half-cell should naturally be resistant to aging to a high degree; additionally, it should distinguish itself—independently of the process conditions existing at the location of measurement—by a high chemical stability and, consequently, by a long service life.

A basic object of the invention is to provide a reference half-cell, a bridge electrolyte and a method for the synthesis of a corresponding bridge electrolyte, with the potential of the reference half-cell, respectively with the bridge electrolyte, being essentially independent of the conditions existing at the location of measurement.

The object is achieved with respect to the reference half-cell in that the reference half-cell includes an electrode element and a bridge electrolyte, that the reference half-cell has an electrode body, in which the bridge electrolyte is located, that the electrode body has a diaphragm, through which the reference half-cell is in electrical contact with the solution being measured, that the bridge electrolyte is formed from a gel, in which a reference electrolyte is incorporated, and that the gel comprises a cationic gel based on diallyldimethylammonium chloride (DADMAC).

Use of conventional, solidified electrolytes of a completely different polymer group as a new, innovative bridge electrolyte makes it possible to manufacture gel-filled electrodes which are distinguished by a markedly lengthened useful life and by improved application properties. Moreover, the cationic gel of the invention can be manufactured in an environmentally friendly manner. By suitable synthesis, it is even possible to prevent major collapse of the gel in the presence of neutral salts. This property is naturally indispensable for use of a gel as a bridge electrolyte in a pH-electrode.

With reference to the bridge electrolyte of the invention, the object is achieved in that the reference electrolyte is incorporated into a cationic gel based on diallyldimethylammonium chloride (DADMAC). The bridge electrolyte is used in a reference half-cell, which is applied in connection with a potentiometric measuring chain determining ion concentration in a solution being measured. A reference half-cell equipped with the bridge electrolyte of the invention fulfills the above-listed, demanding requirements for a stably operating reference half-cell. Diallyldimethylammonium chloride (DADMAC) is, moreover, commercially available without problem.

Application of the completely new-kind of bridge electrolyte of the invention and its application in the reference half-cell of a potentiometric measuring chain provides marked advantages compared to the old and conventional solutions. The reference half-cells produced using the bridge electrolyte of the invention distinguish themselves especially by an increased signal stability and by an increased lifetime. This is true even under constantly changing process conditions.

The cationic gel can be a liquid gel, a particulate gel, or a cationic gel having a solid gel matrix. The requisite consistency, respectively viscosity, of the gels depends on the electrode type and on the particular application.

Preferably, the consistency of the cationic gel is adjustable via the concentration of reactive functions and/or via the concentration of crosslinking agent and/or the type of crosslinking agent. Especially advantageous in this connection is when the reactive functions involve the amount of secondary or tertiary amine groups. Useful as crosslinking agents are bis-glycidyl ethers, for example glycerol propoxylate triglycidyl ether.

The object with respect to a method of the invention for the synthesis of the bridge electrolytes made from a cationic gel based on diallyldimethylammonium chloride (DADMAC) is preferably achieved by the following two method steps: In a first step, linear DADMAC-copolymers having a specified concentration of reactive functions are synthesized; in a second step, the crosslinking of the reactive, linear copolymers then proceeds with multifunctional agents.

A preferred form of embodiment of the method of the invention provides that the synthesis of the reactive, linear copolymer occurs by radical copolymerization of DADMAC with diallylamine or diallylalkylamine in aqueous solution.

In the case of a liquid gel, the synthesis of the bridge electrolyte proceeds preferably outside of the electrode body of the reference half-cell in a reaction vessel; if required, the bridge electrolyte is subsequently filled into the electrode body of a pH-electrode.

In the case that the bridge electrolyte has a solid gel matrix, the synthesis occurs, in contrast, in the electrode body of the reference half-cell. Preferably, the synthesis occurs then during the electrode manufacture. In this connection, it should be mentioned, however, that, from a production point of view, polymerization in the electrode body is not unconditionally of advantage, since only a limited amount of time is available for the filling of the electrode body with the pre-activated monomer solutions. Compared to the conventional manufacture of solid polyacrylamide, the solution of the invention distinguishes itself, however, in that the shelf life of the activated solution can be increased about by a factor of five.

The invention will now be explained in greater detail on the basis of the drawings, whose figures show as follows:

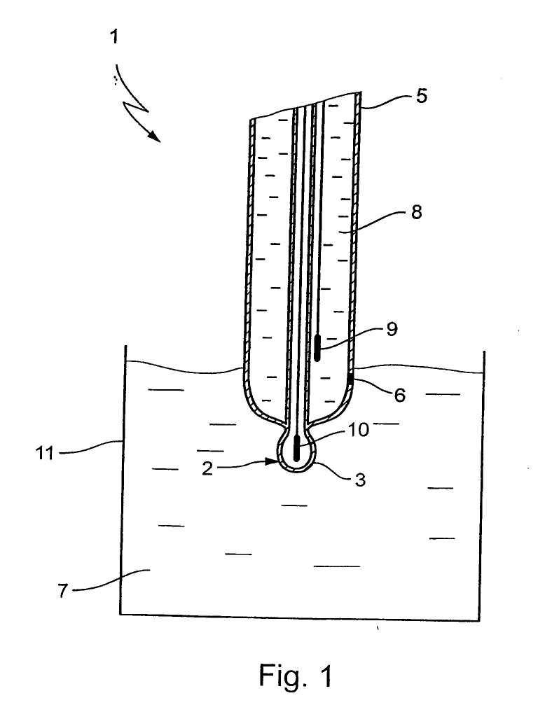

FIG. 1: a schematic representation of a pH-sensor 1, in which the reference half-cell 4 of the invention is used; and

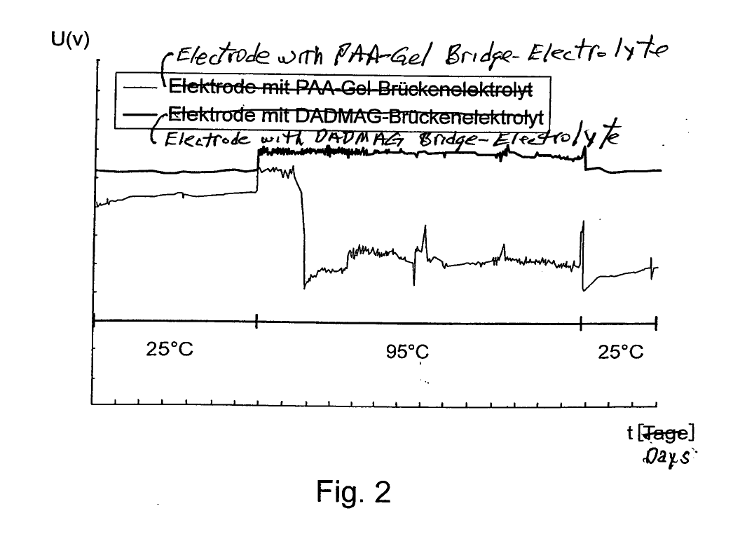

FIG. 2: a diagram visualizing the potential stability of the reference half-cell of the invention.

FIG. 1 shows a schematic representation of a pH-sensor 1, in which the reference half-cell 4 of the invention is used. The pH-sensor is symmetrically constructed, from a mechanical point of view: The reference half-cell 4 is concentrically arranged about the measuring half-cell 2. The measuring half-cell 2 is embodied as a spherical membrane 3. The diaphragm 6 has a ring-shape and is located in the immediate vicinity of the spherical membrane 3 of the measuring half-cell 2. This symmetrical construction of the pH-sensor 1 permits achievement of a high degree of measuring accuracy.

The electrochemical lead system 9, 10 is a silver/silver-chloride system. An electrode plug-in head can be used as the process connection. On the electrode plug-in head, there is usually a coaxial cable screwed on, via which the connection to the pH-measurement transmitter is made. These components of the pH-sensor 1 are not separately shown in FIG. 1. A suitable measurement transmitter for use here is that manufactured by the assignee and sold under the name Mycom.

The securement of the pH-sensor on the container, e.g. in the pipeline, can be done with a retractable assembly, which is likewise not shown separately in FIG. 1. Retractable assemblies are widely known in the state of the art. Preferably, the assembly used in connection with the present invention is of plastic or stainless steel. Appropriate assemblies are e.g. manufactured and sold by the assignee under the designations Probfit, Cleanfit, etc.

According to the invention, a cationic gel based on diallyldimethylammonium chloride (DADMAC) is used as the bridge electrolyte. Through the preparation of linear DADMAC-copolymers with an optimal concentration of reactive functions and subsequent crosslinking with suitable multifunctional agents, the bridge electrolyte of the invention can be prepared using a two-stage process. In the first step, a reactive, linear, polymeric intermediate is manufactured, which is then subsequently converted into the networks by chain linking.

The synthesis of the reactive, linear copolymers occurs in the first stage by radical copolymerization of DADMAC with diallylamine or diallylalkylamine (e.g. 1-20 mol %) in aqueous solution. The resulting, aqueous polymer solution can, in principle, be used for the subsequent gel formation without further cleaning. In a second stage, the copolymer is prepared as a 1-20% solution in e.g. 3N KCl-solution and mixed with an up to double equimolar amount of a bis-glycidyl ether. The temperature required for the gel formation depends on the active-group content. Feasible crosslinking agents are, for example, glycerol diglycidyl ether or PEG(9)-bis-glycidyl ether.

By varying the concentration of reactive functions in the copolymer—the reactive functions are a matter, for example, of the amount of secondary or tertiary amine groups—and with variation of the concentration of crosslinking agent or the type of crosslinking agent, a broad palette of materials of varying consistency can be obtained. Depending on composition, the bridge electrolytes of the invention can involve liquid gels, particulate gels or gels having a solid gel matrix.

The required viscosity of the gels depends on electrode type and purpose of use. The following are possible synthesis methods for a solid gel and a liquid gel:

Solid gel:—Starting prepolymer solution with 2 to 4 mol % sec. amine, 3% in 3N KCl
Crosslinking agent PEG(9) equimolar
Temperature 50° C. in the case of more than 1 hour
Crosslinking in electrode

Liquid gel:—Starting prepolymer solution with 2 to 4 mol % sec. amine, 8% in 3N KCl
Crosslinking agent PEG(9) equimolar
Temperature 80° C. in the case of more than 1 hour, dilution to about 3% possible
Crosslinking outside of the electrode

The cationic gel based on poly-DADMAC distinguishes itself by a very good chemical resistance. Moreover, due to its high hydrolysis resistance, it has a high degree of stability with respect to aging.

The advantageous measuring behavior of a pH-sensor 1 utilizing the reference half-cell 4 of the invention, respectively the bridge electrolyte 8 of the invention, is visualized in the case of temperature stress on the basis of the voltage curves with respect to time as presented in FIG. 2.

In the illustrated case, the voltage curves of two reference half-cells 4 are shown, wherein both cells have the same construction but are filled with different bridge electrolytes. The solution 7 being measured was a NaOH-solution. Both reference half-cells 4 were measured against the same external reference electrode. The common external reference electrode was held at 25.0° C. during the entire experiment.

The recording of the voltage curves occurred first at 25.0° C. Under these moderate stress conditions, no essential difference between the potential stability of the reference half-cell 4 of the invention and the conventional reference half-cell are evident over the time span studied. However, if the temperature of the measuring environment warms, in the illustrated case to 95.0° C., then obvious differences in the potential stability of the two reference half-cells are observed. The reference half-cell with the conventional polyacrylamide (PAA) is no longer constant under these process conditions. This is made quite noticeable by a relatively major potential variation. In the case of the reference half-cell 4, in which the DADMAC bridge electrolyte 8 of the invention is used, only the temperature dependence of the potential is observed. This dependence can be removed by a corresponding temperature compensation. After cooling to the original 25.0° C., the beginning potential value is reached again without problem in the case of the reference half-cell 4 of the invention, while the reference half-cell with a conventional bridge electrolyte basically keeps the potential value seen at the higher process temperature.

1-11. (canceled)

12. A reference half-cell for use with a potentiometric measuring cell for determining ionic activities in a solution being measured, including an electrode body, in which a bridge electrolyte is located; and
a diaphragm formed as part of said electrode body, via which the reference half-cell is in electrical contact with the solution being measured, wherein:
said bridge electrolyte is formed from a gel, in which the reference electrolyte is incorporated, and
said gel is a cationic gel based on diallyldimethylammonium chloride (DADMAC).

13. A bridge electrolyte for use in a reference half-cell, which is used in connection with a potentiometric measuring chain, which determines ion concentration in a solution being measured, comprising:
a cationic gel based on diallyidimethylammonium chloride (DADMAC), in which the reference electrolyte is incorporated.

14. The bridge electrolyte as claimed in claim 13, wherein:
said cationic gel is prepared by a two-stage process.

15. The bridge electrolyte as claimed in claim 13, wherein:
said cationic gel is one of: a liquid gel, a particulate gel, and a cationic gel having a solid gel matrix.

16. The bridge electrolyte as claimed in claim 14, wherein:
the consistency of the cationic gel is adjustable via the concentration of reactive functions and/or via the concentration of the crosslinking agent and/or the type of crosslinking agent.

17. The bridge electrolyte as claimed in claim 16, wherein:
the concentration of reactive functions concerns the amount of secondary or tertiary amine groups.

18. The bridge electrolyte as claimed in claim 16, wherein:
the crosslinking agent is a bis-glycidyl ether.

19. A method for synthesis of a bridge electrolyte, which comprises the steps of:
providing a cationic gel based on diallyldimethylammonium chloride (DADMAC) which is usable in a reference half-cell;
providing as a first step, linear DADMAC-copolymers with a specified concentration of reactive functions which are synthesized; and
providing as a second step, the crosslinking of the reactive, linear copolymers which occurs with multifunctional agents.

20. The method as claimed in claim 19, wherein:
the synthesis of the reactive, linear copolymer occurs by radical coplymerization of DADMAC with diallylamine or diallylalkylamine in aqueous solution.

21. The method as claimed in claim 19, wherein:
in the case of a liquid gel, the synthesis of the bridge electrolyte occurs outside of the electrode body of the reference half-cell in a reaction vessel; and
subsequently, the bridge electrolyte is filled into the electrode body.

22. The method as claimed in claim 19, wherein:
in the case in which the bridge electrolyte has a solid gel matrix, the synthesis occurs in the electrode body of the reference half-cell.
